(19) United States
(12) Patent Application Publication
(10) Pub. No.: US 2022/0186332 A1
(43) Pub. Date: Jun. 16, 2022

(54) METHOD AND DEVICE FOR INDUCTION HARDENING

(71) Applicant: Liebherr-Components Bibearch GmbH, Bibearch an der Riss (DE)

(72) Inventor: Heiko SCHWIBODE, Bad Waldsee (DE)

(73) Assignee: Liebherr-Components Bibearch GmbH, Bibearch an der Riss (DE)

(21) Appl. No.: 17/650,365

(22) Filed: Feb. 8, 2022

Related U.S. Application Data
(63) Continuation of application No. PCT/EP2020/072259, filed on Aug. 7, 2020.

(30) Foreign Application Priority Data
Aug. 9, 2019 (DE) 10 2019 121 591.9
Oct. 10, 2019 (DE) 10 2019 127 231.9

(51) Int. Cl. C21D 9/32; B33Y 80/00; C21D 9/24; C21D 1/42; C21D 1/10; H05B 6/10; H05B 6/40; H05B 6/42

(52) U.S. Cl. CPC C21D 9/32; B33Y 80/00; C21D 9/24; C21D 1/42; B33Y 10/00; H05B 6/101; H05B 6/405; H05B 6/42; C21D 1/10

(57) ABSTRACT

The invention relates to a method for the induction hardening of a workpiece, in particular a toothed and/or corrugated and/or ribbed workpiece such as a gear or saw blade, wherein a matchingly shaped induction loop is guided or set over the workpiece surface to be hardened, the induction loop being formed layer-by-layer by the additive application of material, and the induction loop being shaped to match the surface to be hardened.

### CROSS-REFERENCE TO RELATED APPLICATIONS

This application is a continuation of International Patent Application Number PCT/EP2020/072259 filed Aug. 7, 2020, which claims priority to German Patent Application Numbers DE 10 2019 121 591.9 filed Aug. 9, 2019 and DE 10 2019 127 231.9 filed Oct. 10, 2019, all of which are incorporated herein by reference in their entireties.

### BACKGROUND

The present invention relates to a method and a device for the induction hardening of a workpiece, in particular a toothed and/or corrugated workpiece such as a gear, sprocket wheel or saw blade, wherein a matchingly shaped induction loop is guided or set over the surface to be hardened.

In induction hardening, as is known, an induction loop is brought close to or passed over the surface of a workpiece to be hardened, wherein a voltage is induced by applying an alternating voltage or, if necessary, by moving relative to a magnetic field, which induces eddy currents in the workpiece and partially heats the workpiece. For workpieces of sufficient size, the heat flows off sufficiently quickly into the rest of the still cold workpiece so that hardening occurs, although quenching can also be performed if necessary. By controlling the frequency, the penetration depth or hardness penetration depth can be controlled, and the degree of heating can be influenced by the current intensity and duration of the power supply. All in all, through induction hardening, there can be heated even more complicated contoured workpieces to the required hardening temperature in a targeted manner within just limited areas, and therefore partially hardened.

For achieving an even hardening result over the contour course on more complex surfaces such as toothings or corrugations or ripples, the induction loops are adapted in shape to the tooth or shaft contour or generally to the surface contour to be hardened in order to achieve possibly a constant distance between the surface contour to be hardened and the contour of the induction loop or to purposefully vary this distance over the length of the induction loop if a correspondingly non-constant course of the hardening depth is desired.

Typically, induction loops are hollow so that they can be cooled with water or other cooling medium during the hardening process. Accordingly, the induction loops are made by bending and joining individual tubes, which usually have a rectangular or square cross-section. Depending on the required contour of the induction loop, different pieces of tubing are cut to size, trimmed, bent and joined by soldering to match the shape of the induction loop to the surface contour of the workpiece to be hardened. However, due to said cutting, sawing, bending and soldering, the freedom of geometry of the induction loops is limited or the production of the desired induction loop contour becomes very difficult and expensive.

During the hardening process, the induction loop must not touch the workpiece and is separated by a predefined gap between the workpiece and the induction loop. The gap width is determined by adapting the induction loop to the contour of the workpiece or its surface to be hardened. Due to the limited geometric adaptability of the induction loop to the workpiece, induction loops currently match the shape only to individual segments of the workpiece, wherein the workpiece is gradually inductively hardened at its individual segments. For example, when hardening the teeth of a gear or rack, there are usually used induction loops which are usually shape matched to only one tooth gap between two adjacent tooth flanks or to a maximum of two to three such tooth gaps. In this respect, the induction loop is guided through the tooth gap by a feed movement parallel to the axis of rotation of the gear or transversely to the longitudinal direction of the rack, wherein subsequently the induction loop or the gear or the rack is set a little further and through a repeated feed movement the induction loop is guided through a still unhardened tooth flank. In this way, the toothing is induction-hardened piece by piece.

In said tooth gap hardening, the induction loop is thus matchingly shaped to at least two adjacent tooth flanks as well as the foot area in between. The advantage of gap hardening, in contrast to single tooth hardening, is that there is achieved an even hardening, especially in the highly stressed tooth root area, while hardness irregularities due to the cyclical reapplication of the induction loop in the next gap or group of gaps occur only in the area of the tooth head. Nevertheless, in the case of more complex gear geometries, it would be desirable to be able to avoid hardness irregularities in the tooth root area as well as in the tooth head area.

In principle, it would also be desirable to be able to inductively harden a larger group of teeth or tooth gaps or similar shaft or general surface contours simultaneously in order, on the one hand, to reduce the overall production time required for the hardening process and, on the other hand, to have as few hardening irregularities as possible due to repeated reapplication of the induction loop. Similarly, in order to control the hardening process as precisely as possible, it is desirable to keep deviations in shape between the induction loop and the surface contour to be hardened as small as possible or to maintain the distance between the induction loop and the surface contour as precisely as possible.

In order to be able to harden several teeth or tooth gaps of a gear at the same time, the EP 23 10 542 B1 document proposes to use several induction loops or hardening inductors distributed around the circumference of the gear, at a distance from each other corresponding to an integer multiple of the sector angle of two adjacent teeth. By further rotating the gear according to the pitch of the toothing, simultaneously, through the gaps between the teeth, there can always be passed several induction loops. However, the hardness irregularities in the area of the tooth tips remain. In addition, the hardening time remains considerable, since a large number of hardening cycles and corresponding rotational movement of the gear or hardening device are required.

Document EP 22 64 192 A1 has proposed induction hardening of gears under inert gas, with the inert gas surrounding at least the sector to be hardened in order to prevent scaling of the tooth flank surfaces. The shape of the induction loop is matchingly shaped to the tooth gap to be hardened.

Document DE 10 2011 053 139 A1 has proposed the use of an induction coil with an S-shaped curvature for hardening the rack toothing in order to direct the induced current at least partially orthogonally to the tooth flanks.

In order to achieve an even hardening depth even with more complex gear geometries, the document DE 10 2008 041 952 B4 proposes to provide for simultaneous application of different frequencies.

Further devices for the induction hardening of gear teeth are known from the DE 956 259 B and DE 969 927 B.

### SUMMARY

It is the underlying object of the present invention to provide an improved method and an improved device for the induction hardening of a workpiece that avoid disadvantages of the prior art and advantageously further develop the latter. In particular, a homogeneous hardening result without undesired hardness irregularities or variations should also be achieved for more complex contoured workpieces with a hardening process that can be carried out efficiently and requires short production times without excessive tool costs.

Said task is solved, according to the invention, with a method as claimed in claim 1 and a device as claimed in claim 7. Preferred embodiments of the invention are the subject-matter of the dependent claims.

It is therefore proposed to build up the induction loop used for hardening the respective workpiece layer-by-layer in the required contour by additive material deposition, thereby eliminating the geometry limitations of conventional induction loops as they are given by sawing, bending and brazing of tube sections. According to the invention, the induction loop is formed layer-by-layer by additive material application, in particular built up layer-by-layer and, for example, thermally solidified, and thereby adapted in shape to the surface of the workpiece to be hardened. Due to the additive material application and the resulting layer-by-layer contour, the induction loop can be very precisely matched in shape even to more complex surface contours such as gear teeth, so that the gap or distance to be maintained between the induction loop and the workpiece surface during hardening can be precisely formed.

In particular, the induction loop can be manufactured using a 3D printing process, wherein the induction loop can be built up, for example, by building it up layer-by-layer in the 3D printer and, if necessary, solidified by thermal post-treatment.

In particular, material layers can be successively liquefied and/or solidified layer-by-layer by means of an energy beam. For example, one or more materials can be applied in layers in pulverulent and/or paste-like and/or liquid form and melted or solidified and/or cured and/or chemically reacted by a laser beam or electron beam or plasma beam to form a cured layer. This layered formation allows the induction loop to be precisely adapted in shape to difficult contours with changing curvatures and/or angular transitions between different straight lines and/or curved contour sections, even with small surface contours, so that the gap between the induction loop and the workpiece surface required for hardening can be kept constant over the surface contour or varied in the desired manner, thus enabling very homogeneous hardening results to be achieved.

In an advantageous further development of the invention, the induction loop can be matchingly shaped to the surface to be hardened over many tooth, corrugation or ripple contours, thus avoiding hardness irregularities, for example at the tooth tip or even in a tooth root. In particular, the induction loop can be matchingly shaped to more than three or more than five or even more than ten or also any number of—preferably adjacent in each case—tooth gaps or wave troughs or teeth or waves or dents or projections and depressions or generally recesses or elevations of the workpiece at the same time by forming the induction loop layer-by-layer by additive material deposition in the manner mentioned and thereby shaping it matchingly to the surface contour. By means of such an induction loop, said more than three or more than five or even more than ten tooth gaps or corrugation dips or recesses and projections can be hardened simultaneously. The simultaneous hardening of such a large number of surface contour segments on the one hand significantly reduces the production time required for hardening. On the other hand, hardness irregularities arising during the tooth by tooth, cyclic reapplication of an induction loop matched to the shape of only one tooth gap are avoided.

In particular, by means of said induction loop also more than 25% or more than 50% or more than 75% of the entire toothing and/or corrugation and/or surface contour to be hardened can be simultaneously enclosed or covered by the induction loop and hardened at the same time. In further development of the invention, it can also be provided that the induction loop is matchingly shaped to the entire surface contour to be hardened and the entire surface contour of the workpiece to be hardened is hardened simultaneously. If, for example, a gear is hardened, the induction loop can surround one-third or two-thirds of the circumference or even the entire circumference of the gear and, in doing so, be adapted to the contours of the tooth gaps or tooth flanks and tooth tips exactly or in the desired manner in terms of shape in order to have an even or in the desired manner varying distance between the induction loop and the gear tooth profile contour and, accordingly, to achieve a homogeneous hardening result.

If, on the other hand, there is hardened a rack, the induction loop can extend, for example, over a quarter or half or three quarters of the length or even the entire length of the rack or the toothed area of the rack and be matchingly shaped to the tooth gaps and tooth flanks and tooth tips covered in the process.

Advantageously, the induction loop can be made hollow on the inside by the layer-by-layer additive material application to form a coolant passage inside the induction loop. Cooling medium in or flowing through the coolant passage, such as a water-polymer solution mixture or oil or other liquid cooling medium, can cool or protect the induction loop from overheating during hardening or also keep it at the desired temperature. Despite possibly complex loop contours, 3D printing can be used to form a hollow loop profile with a coolant passage inside.

### BRIEF DESCRIPTION OF THE DRAWINGS

The invention will be explained in more detail in the following with respect to preferred embodiments and to associated drawings. The drawings show:

FIG. 1: A side view of an induction loop of a device for induction hardening of a gear, which extends over the entire outer circumference of the gear and is precisely matchingly shaped to the contour of the tooth gaps and teeth, with the axis of view corresponding to the representation of the axis of rotation of the gear;

FIG. 2: a perspective view of the induction loop surrounding the gear to be hardened in a viewing direction obliquely with respect to the axis of rotation of the gear, showing the contour of the induction loop adapted to the shape of the toothing;

FIG. 3: a side view of a gear and an induction loop matchingly shaped to its toothing, which in contrast to the explanations according to FIGS. 1 and 2 is matchingly shaped only at three or more tooth gaps and has inlets and outlets for a coolant at the end;

FIG. 4: a perspective view of the induction loop of FIG. 3 partially surrounding the gear to be hardened in a viewing direction obliquely with respect to the axis of rotation of the gear;

FIG. 5: A side view of a gear and an induction loop adapted in shape to its toothing, the induction loop comprising two partial induction loops for simultaneous hardening and being contoured in such a way that the gap between the induction loop and the toothing surface contour has a non-constant, predetermined gap dimension;

FIG. 6: a perspective view of the gear and the surrounding induction loop from FIG. 5 in a viewing direction obliquely with respect to the axis of rotation of the gear;

FIG. 7: a side view of a two-stage toothed gear for simultaneous hardening and an induction loop adapted to the shape of different toothed areas for simultaneous hardening of the different tooth stage areas; and

FIG. 8: a perspective view of the gear and the surrounding induction loop from FIG. 7 in a viewing direction obliquely with respect to the axis of rotation of the gear rim;

### DETAILED DESCRIPTION

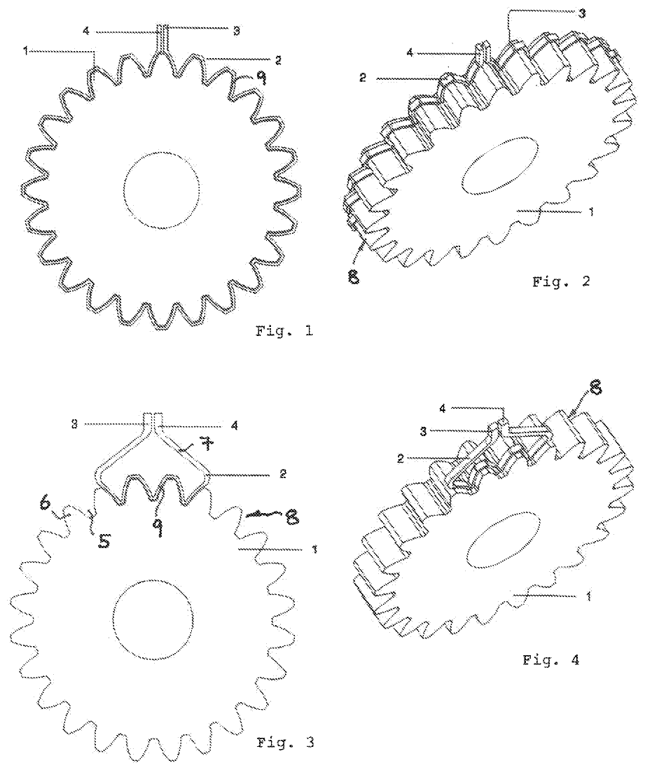

As shown in FIGS. 1 and 2, the induction loop 2 can be used to partially harden the toothing 8 of a toothed workpiece 1, said toothed workpiece 1 being a gear or a rack. As explained at the beginning, however, other workpieces with similar corrugated or grooved contours or with differently contoured surfaces can also be induction hardened in a corresponding manner.

Advantageously, the induction loop 2 can simultaneously cover at least a large part of the toothing 8, in particular also the entire toothing 8, as shown in FIGS. 1 and 2.

The induction loop 2 is produced in an additive material deposition process, in particular with a 3D printing process, wherein the induction loop can be built up by layer-by-layer build-up in the 3D printer and, if necessary, solidified by thermal post-treatment. The induction loop is advantageously made of an electrically conductive, in particular metallic, material.

The induction loop 2 can be formed with a round or rounded, flattened, for example elliptical, but also an angular, in particular rectangular or square cross-section. Furthermore, the induction loop can have any cross-section if required by the geometric conditions of the workpiece to be hardened.

As FIGS. 1 and 2 show, the induction loop 2 can be precisely matchingly shaped to the toothing 8 by the additive, layer-by-layer application of material, and in particular can be precisely matchingly shaped to the tooth gaps 5 and the teeth 6 of the toothing 8, so that a gap 9 between the induction loop 2 placed over the toothing 8 and the tooth and tooth gap contours can be maintained exactly constant, so that a gap dimension along the longitudinal extent of the induction loop 2 remains at least substantially constant. In this way, a desired hardening result, for example an even hardening depth, can be achieved.

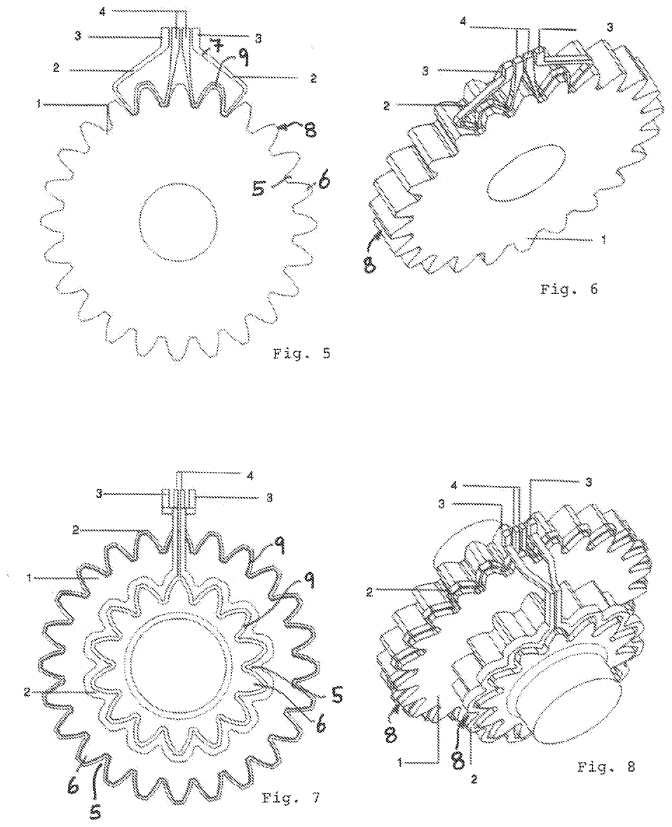

However, the induction loop 2 can also be specifically shaped deviating from the contour of the surface to be hardened, in particular the toothing 8, by the additive material application and the layer-by-layer formation in order to achieve a defined course of the gap dimension of the gap 9, for example a slightly larger gap dimension at the tips of the teeth 6 than at the bottom of the tooth gaps 5, as shown in FIGS. 5 and 6. In particular, the induction loop 2 can be formed in the 3D printing process such that the gap dimension along the induction loop 2 changes continuously and/or cyclically to achieve the desired hardening depth profile.

As shown in FIGS. 1 and 2, the induction loop 2 can extend around the entire circumference of the gear and/or extend across the entire toothing 8, matching the contours of the teeth and tooth gaps.

As shown in FIGS. 1 and 2, the width of the induction loop 2 can be smaller than the thickness of the workpiece 1. In the induction hardening process, the induction loop 2 can be guided by an advancing movement across the entire width of the workpiece 1, and such an advancing movement can be performed in the direction of the rotation axis of the gear by the induction loop 2 and/or by the workpiece 1 to be hardened. The induction loop 2 is shifted across the workpiece 1 parallel to the tooth flanks of the teeth 6 or parallel to the bottom of the tooth gaps 8 in order to harden the toothing 8 over its entire width.

Alternatively, however, it would also be possible to make the induction loop 2 wider, so that the width of the induction loop 2 corresponds to the thickness of the workpiece 1 or is even greater.

As FIGS. 1 and 2 shown, the induction loop 2 may advantageously have a coolant inlet 3 and a coolant outlet 4 to be able to feed into a coolant passage 7 extending inside the induction loop 2, in particular to be able to circulate through said coolant passage 7 and to cool the induction loop 2 by the coolant in the coolant passage 7 during hardening.

Said coolant passage 7 is formed inside the induction loop 2 during the layer-by-layer formation of the induction loop 2 by additive material deposition.

As FIGS. 3 and 4 shown, however, the induction loop 2 can, if necessary, also cover only a partial section of the toothing 8, for example extending across three adjacent tooth gaps 5. Here, too, it can be advantageously provided that the induction loop 2 fits precisely to the contours of the tooth gaps 5 and the teeth 6 bounding the tooth gaps 5, so that a gap 9 with a constant gap dimension is achieved. Said gap dimension can be essentially constant from the bottom of the tooth gaps 5 over the tooth flanks to the tips or heads of the teeth 6, as shown in FIG. 3.

In order to harden the entire toothing 8, after the hardening cycle of the tooth gaps 5 covered by the induction loop 2, the workpiece 1 can be further rotated by an angle corresponding to the angle between the outermost tooth gaps covered by the induction loop 2. In other words, the gear is rotated further by three teeth in order to be able to insert the induction loop 2 into three not yet hardened tooth gaps 5. Alternatively, the gear can also be rotated further by an integral multiple of the said angle, for example by six or nine teeth. Alternatively or in addition to turning the gear further, the induction loop 2 can also be turned accordingly, i.e. moved further in the circumferential direction of the gear.

As FIGS. 5 and 6 show, the shape of the induction loop 2 can also be adapted to the contour of the toothing 8 in such a way that the gap 9 between the induction loop 2 and the toothing 8 does not remain exactly constant but varies, in particular continuously and/or steadily increasing and decreasing again, in order to achieve different hardening results, in particular different hardening depths, at different sections of the toothing 8.

Separately, as FIGS. 5 and 6 show, two or more induction loops 2 may also be used simultaneously, each of which may have a coolant inlet 3 and a coolant outlet 4. Advantageously, the coolant inlet ports 3 and the coolant outlet ports 4 can each be supplied from a common inductor base.

As FIGS. 7 and 8 shown, separate contour sections can also be hardened simultaneously on a workpiece 1. One or more induction loops 2 can be matchingly shaped to different contour sections of the workpiece 1, wherein said contour sections can in particular have different diameters and/or be axially spaced from one another.

As FIGS. 7 and 8 show, a toothed workpiece 1 may have two separate toothings 8, which may, for example, have different numbers of teeth and/or different pitch diameters. For example, a stepped ring gear with two teeth 8 can be hardened by assigning an induction loop 2 to both teeth 8 simultaneously. Each induction loop 2 can be adapted exactly to the shape of the toothing contour in said manner, if necessary with a desired variation of the gap dimension.

Advantageously, the induction loop 2 can completely surround both toothings 8, although, similar to FIGS. 3 to 6, only a partial sector of one or both toothings 8 can be covered by the induction loop 2.

As FIGS. 7 and 8 show, two separate inductor loops 2 can be used, each of which can have a coolant inlet 3 and a coolant outlet 4 that can be supplied from a common inductor base. Alternatively, however, it would also be possible to form a continuous induction loop 2 that encloses both toothings 8 in a correspondingly matchingly shaped manner.

We claim:

1. A method for the induction hardening of a toothed and/or corrugated and/or ribbed workpiece comprising a gear, sprocket wheel, or saw blade, wherein the workpiece has a surface, the method comprising:
guiding or setting over the workpiece surface a matchingly shaped induction loop,
forming the induction loop layer by layer by the additive application of material, wherein the induction loop is shaped to match the surface of the workpiece.

2. The method of claim 1, wherein the forming comprises a 3D printing process by a 3D printing head and matchingly shaping the induction loop to the surface of the workpiece to be hardened during the 3D printing process, further comprising building up the induction loop comprising a layer-by-layer construction in the 3D printer and, if necessary, a thermal post-treatment comprising solidifying the induction loop.

3. The method of claim 1, wherein the matchingly shaping of the induction loop comprises matchingly shaping to more than three tooth gaps or wave troughs of the workpiece, and further comprising simultaneously hardening more than three tooth gaps of the workpiece by the induction loop.

4. The method of claim 1, wherein forming of the induction loop further comprises forming a hollow in layers by the additive material application in such a way that a coolant passage running through the induction loop is formed, and cooling the induction loop by a cooling medium located in the coolant passage during hardening.

5. The method of claim 1, further comprising simultaneously enclosing and simultaneously hardening by the induction loop more than 25% of a total toothing and/or corrugation and/or ripple contour to be hardened.

6. The method of claim 1, further comprising shaping the induction loop by the additive application layer-by-layer to two different toothing contours of the toothed workpiece which are axially spaced from one another and/or have different diameters, and hardening the different toothing contours of the toothed workpiece simultaneously by the induction loop.

7. A device for induction hardening of a toothed and/or corrugated workpiece comprising a gear, sprocket wheel, or saw blade, wherein the workpiece has a surface, the device comprising:
an induction loop adapted in shape to the surface of the workpiece to be hardened, wherein the induction loop has a layered structural body having material layers, and wherein the material layers are individually consolidated layer-by-layer.

8. The device of claim 7, wherein the induction loop is 3D printed by a 3D printer.

9. The device of claim 7, wherein the induction loop has a coolant passage in an interior of the induction loop.

10. The device of claim 7, wherein the induction loop is matchingly shaped to more than three tooth gaps or wave troughs of the toothed and/or corrugated workpiece and encloses more than three adjacent tooth gaps or wave troughs simultaneously.

11. The device of claim 7, wherein the induction loop has at least one portion with a continuously varying curvature.

12. The device of claim 7, wherein the induction loop has at least one straight portion and at least one curved portion interconnected by a bent portion.

13. The device of claim 7, wherein the induction loop has loop sections matchingly shaped to different sectors of a gear having different diameters from one another.

14. The device of claim 7, wherein the induction loop is matchingly shaped to a toothing comprising a plurality of tooth gaps and a plurality of teeth, and wherein a gap between the induction loop and the toothing has a constant and even gap dimension across the plurality of tooth gaps and the plurality of teeth.

15. The device of claim 7, wherein the induction loop is matchingly shaped to a toothing comprising a plurality of tooth gaps and a plurality of teeth, and wherein a gap between the induction loop and the toothing has a continuously varying gap dimension across the plurality of tooth gaps and the plurality of teeth that cyclically increases and decreases.

16. The device of claim 7, wherein the induction loop extends over more than 25% of the length of a toothing of the workpiece.

17. The device of claim 7, wherein workpiece comprises a gear and/or a rack toothing, and wherein the induction loop extends over an entire toothed circumference of the gear or over an entire length of the rack toothing.

18. The device of claim 7, wherein the induction loop has two separate induction loop sections axially spaced from each other and having enveloping contours of different diameters, wherein the two induction loop sections are matchingly shaped to different teeth of a stepped ring gear.

19. The device of claim 18, wherein each induction loop section surrounds more than three tooth gaps enclosing the entire toothing in each case.

20. The device of claim 7, wherein the induction loop has at least one coolant passage inside.
